(19) United States
(12) Patent Application Publication
(10) Pub. No.: US 2007/0197401 A1
(43) Pub. Date: Aug. 23, 2007

(54) SANDSTONE HAVING A MODIFIED WETTABILITY AND A METHOD FOR MODIFYING THE SURFACE ENERGY OF SANDSTONE

(76) Inventors: MANUEL J. ARCO, Woodbury, MN (US); RUDOLF J. DAMS, Antwerp (BE); GEORGE G.I. MOORE, Afton, MN (US); KENNETH D. WILSON, Croix, MN (US)

Correspondence Address: 3M INNOVATIVE PROPERTIES COMPANY, PO BOX 33427, ST. PAUL, MN, 55133-3427, US

(21) Appl. No.: 11/466,611

(22) Filed: Aug. 23, 2006

Related U.S. Application Data
(63) Continuation-in-part of application No. 11/428,731, filed on Jul. 5, 2006, now abandoned.
(60) Provisional application No. 60/813,599, filed on Feb. 21, 2006.

(51) Int. Cl. C09K 8/00; E21B 43/00

(52) U.S. Cl. 507/233; 166/244.1

(57) ABSTRACT

Methods for modifying the wettability of sandstone. Compositions comprising sandstone having a modified wettability. Such wettability modifications may be useful, for instance, in improving the well-deliverability of an oil and/or gas well located in a sandstone formation.

### CROSS REFERENCE TO RELATED APPLICATIONS

This application is a continuation-in-part of U.S. application Ser. No. 11/428,731, filed Jul. 5, 2006, and a continuation-in-part of U.S. application Ser. No. 11/358,641, filed Feb. 21, 2006, which was requested to be converted to a provisional application on Mar. 23, 2006. The disclosures of both applications are incorporated herein by reference.

### BACKGROUND

Fluorochemical compounds are well known and commercially used, for example, to coat various substrates and for surface-energy modification purposes, and may provide desirable macroscopic properties (e.g., soil repellency and soil release).

In other technologies, it has been common practice to inject well stimulation fluids into selected oil- and/or gas-bearing geological formations and/or strata to overcome problems resulting in reduced productivity in such formations. Typically, well stimulation fluids operate by hydraulic fracturing of and/or acidic reaction with the formations and/or strata. The well stimulation fluids may prevent a decrease in the permeability of the formation to oil and/or gas and also prevent a decrease in the rate of delivery of oil and/or gas to the wellhead.

While fluorochemical compounds are known as components in well stimulation fluids, not all fluorochemical-based surface-active agents are suitable as well stimulants. Some do not provide well stimulation, while others provide some stimulation but are too quickly removed from the formations and/or strata during extraction of oil or gas and thus, in practice, do not provide adequate sustained performance.

### SUMMARY

Therefore, there is a continued need for improved well stimulants and well stimulation methods.

In one aspect, the present invention relates to a method for modifying the wettability of sandstone. The method comprises applying a chemical formulation to sandstone bearing at least one of oil or gas. The chemical formulation comprises a polar organic solvent, water, and a fluorochemical represented by the formula:
R_{f}SO₂—N(R)(CₙH₂ₙ)CHZ(CₘH₂ₘ)N(R′)SO₂R_{f},
   wherein
      each R_{f} is independently —CₚF₂ₚ₊₁, where p is an integer from 1 to 8;
      R is selected from the group consisting of an aryl group and a C₁ to C₆ alkyl group;
      m and n are each independently integers from 1 to 20;
      Z is selected from the group consisting of —H and a group having the formula —(CₜH₂ₜ)—X-Q—Si(Y′)_{w}(Y)_{3-w}, in which t is an integer from 0 to 4; -X- is selected from the group consisting of —O—, —S— and —NH—; -Q- is selected from the group consisting of —C(O)NH—(CH₂)ᵥ— and —(CH₂)ᵥ—; v is an integer from 1 to 20; Y is a hydrolyzable group; Y′ is a non-hydrolyzable group; and w is an integer from 0 to 2; and
      R′ is selected from the group consisting of R and a group represented by the formula —(CH₂)ᵥ—Si(Y′)_{w}(Y)_{3-w}, with the proviso that when Z is —H, R′ is a group represented by the formula —(CH₂)ᵥ—Si(Y′)_{w}(Y)_{3-w}.
         The chemical formulation also comprises a catalyst for hydrolyzing the Si—Y bond. The catalyst comprises an acid compound or alkaline compound. In some embodiments, p is an integer from 2 to 5.

In another aspect, the method further comprises covalently bonding the sandstone to a side-chain derived from the fluorochemical. The side-chain is represented by the formula:

[R_{f}SO₂—N(R)(CₙH₂ₙ)]₂CHZ′

wherein
each R_{f} is independently —CₚF₂ₚ₊₁, where p is an integer from 1 to 8;
each R is independently selected from the group consisting of an aryl group and a C₁ to C₆ alkyl group;
n is an integer from 1 to 20; and
Z′ is a group of the formula —(CₜH₂ₜ)—X-Q—Si(Y′)_{w}—, in which t is an integer from 0 to 4; -X- is selected from the group consisting of —O—, —S— and —NH—; -Q- is selected from the group consisting of —C(O)NH—(CH₂)ᵥ— and —(CH₂)ᵥ—; v is an integer from 1 to 20, Y′ is a non-hydrolyzable group, and w is an integer from 0 to 2.
   In this general structure, the Si atom shares at least one covalent bond with the sandstone and may share up to three covalent bonds with the sandstone. In some embodiments, p is an integer from 2 to 5.

In yet another aspect, the present invention relates to a composition comprising a sandstone bearing at least one of oil or gas. The composition can further comprise a side-chain covalently bonded to the sandstone, wherein side-chain is represented by the formula:

[R_{f}SO₂—N(R)(CₙH₂ₙ)]₂CHZ′

wherein
each R_{f} is independently —CₚF₂ₚ₊₁, where p is an integer from 1 to 8;
each R is independently selected from the group consisting of an aryl group and a C₁ to C₆ alkyl group;
n is an integer from 1 and 20; and
Z′ is a group of the formula —(CₜH₂ₜ)—X-Q—Si(Y′)_{w}—, in which t an integer from 0 to 4; -X- is selected from the group consisting of —O—, —S— and —NH—; -Q- is selected from the group consisting of —C(O)NH—(CH₂)ᵥ— and —(CH₂)ᵥ—; v is an integer from 1 to 20;Y′ is a non-hydrolyzable group, w is an integer from 0 to 2, and the Si shares at least one covalent bond with the sandstone.

### In some embodiments, p is an integer from 2 to 5.

In some embodiments, the methods of the present invention modify the wettability of sandstone bearing at least one of oil or gas. In some of these embodiments, the sandstone is a subterranean gas reservoir that is blocked by liquid hydrocarbons (gas condensate, e.g., at least one of methane, ethane, propane, butane, hexane, heptane, or octane) near the well bore. In some instances, the wettability modification increases fluid mobility through the sandstone. When used in oil and/or gas bearing formations, such an increase in fluid mobility may correspond to higher hydrocarbon production for a well located on the formation. In contrast with existing methodologies, modification using the fluorochemicals described herein may provide tenacious, and in some embodiments permanent, wettability alteration, and/or generally do not decrease permeability.

### BRIEF DESCRIPTION OF THE DRAWINGS

FIG. 1 shows a comparison of n-decane imbibition for Example 1.

FIG. 2 shows a comparison of water imbibition for Example 2.

FIG. 3 shows a comparison of the pressure drop from n-decane injection for Example 3.

FIG. 4 shows a comparison of the pressure drop from water injection for Example 4.

FIG. 5 shows a comparison of relative permeabilities of nitrogen and n-decane for Example 5.

### DETAILED DESCRIPTION

In one aspect, methods described herein include applying a chemical formulation to sandstone bearing at least one of oil or gas. The chemical formulation comprises a polar organic solvent, water, a fluorochemical silane, and a catalyst.

The formulation described herein contains at least one fluorochemical silane of the formula I:

R_{f}SO₂—N(R)(CₙH₂ₙ)CHZ(CₘH₂ₘ)N(R′)SO₂R_{f} (I)
wherein
   each R_{f} is independently —CₚF₂ₚ₊₁, where p is an integer from 1 to 8;
   R is selected from the group consisting of an aryl group and C₁ to C₆ alkyl group;
   m and n are each independently integers from 1 to 20;
   Z is selected from the group consisting of —H and a group having the formula —(CₜH₂ₜ)—X-Q—Si(Y′)_{w}(Y)_{3-w}, in which t is an integer from 0 to 4; -X- is selected from the group consisting of —O—, —S— and —NH—; -Q- is selected from the group consisting of —C(O)NH—(CH₂)ᵥ— and —(CH₂)ᵥ—; v is an integer from 1 to 20; Y is a hydrolyzable group; Y′ is a non-hydrolyzable group; and w is an integer from 0 to 2; and
   R′ is selected from the group consisting of R and a group represented by the formula —(CH₂)ᵥ— Si(Y′)_{w}(Y)_{3-w}, with the proviso that when Z is —H, R′ is a group represented by the formula —(CH₂)ᵥ—Si(Y′)_{w}(Y)_{3-w}.

The perfluoroalkanesulfonamido groups (R_{f}SO₂N—) may be the same or different. The perfluoroalkyl groups may each contain 1 to 8 carbon atoms and may be linear, branched or cyclic. In some embodiments, each R_{f} has 4 carbon atoms (i.e., p is 4). In some embodiments, each R_{f} has 2 to 5 carbon atoms (i.e., p is 2 to 5).

In formula I, m and n may each independently be integers from 1 to 20. In some embodiments, each m and n is independently an integer from 1 to 6. Throughout this application, integer ranges from X to Y are understood to include the endpoints, X and Y.

In some embodiments of the fluorochemical, p is 4, R is —CH₃, m and n are both 1, and Z is selected from the group consisting of —O—(CH₂)₃Si(OCH₂CH₃)₃, —O—(CH₂)₃Si(OCH₃)₃, —OC(O)NH—(CH₂)₃ Si(OCH₂CH₃)₃, and —OC(O)NH—(CH₂)₃ Si(OCH₃)₃. In some of these embodiments, R′ is —CH₃.

The term “alkyl” as used herein, refers to straight chain, branched, and cyclic alkyl. For example, C₁ to C₆ alkyl includes methyl, ethyl, propyl, isopropyl, butyl, cyclobutyl, isobutyl, and tertiary butyl. In some embodiments, each R is independently —CH₃ or —CH₂CH₃. In some embodiments, R and R′ are each independently —CH₃ or —CH₂CH₃. In some embodiments, R and R′ are each —CH₃.

The term “aryl” as used herein includes aromatic rings or multi-ring systems optionally containing one or more ring heteroatoms (e.g., O, S, N). Examples of aryl groups include phenyl, naphthyl, biphenyl, and pyridinyl. Aryl groups may be unsubstituted or may be substituted by one or up to five substituents such as alkyl, as above defined, alkoxy of 1 to 4 carbon atoms, halo (e.g., fluoro, chloro, bromo, iodo), hydroxyl, amino, and nitro. When substituents are present, halo and alkyl substituents are preferred.

In some embodiments of formula I, v is 1 to 10, and in some embodiments, v is 3.

The term “hydrolyzable group” refers to a group which either is directly capable of undergoing condensation reactions under appropriate conditions or which is capable of hydrolyzing under appropriate conditions, to yield a compound that is capable of undergoing condensation reactions. Appropriate conditions include acidic or basic aqueous conditions, optionally in the presence of another condensation catalyst (in addition to the acid or base).

The hydrolyzable groups Y may be the same or different and are generally capable of hydrolyzing under appropriate conditions. Appropriate conditions include, for example, acidic or basic conditions in the presence of water. Hydrolysis of the Y groups may allow the fluorochemical to participate in condensation reactions. The hydrolyzable groups upon hydrolysis may yield groups capable of undergoing condensation reactions, such as silanol groups.

Examples of hydrolyzable groups include, for instance, halogens such as chlorine, bromine, iodine, or fluorine; alkoxy groups of the general formula —OR″ (wherein, R″ represents a lower alkyl group, preferably containing 1 to 6 carbon atoms, which may optionally be substituted by one or more halogen atoms); acyloxy groups of the general formula —O(CO)—R″ (wherein R″ is as indicated for the alkoxy groups); aryloxy groups of the general formula —OR′″ (wherein R′″ represents an aryl moiety that may contain, for instance, 6 to 12 carbon atoms, which may further optionally be substituted by one or more substituents independently selected from halogens and C₁ to C₄ alkyl groups, the C₁ to C₄ alkyl groups optionally being substituted by one or more halogen atoms); or poly(oxyalkylene)groups, in which the oxyalkylene unit in the poly(oxyalkylene) group preferably has 2 or 3 carbon atoms, such as —OCH₂CH₂—, —OCH₂CH₂CH₂—, —OCH(CH₃)CH₂—, and —OCH₂CH(CH₃)—; the oxyalkylene units can be the same, as in poly(oxyethylene), or present as a mixture, as in straight or branched chain or randomly distributed oxyethylene and oxypropylene units. In each of these formulae, R″ and R′″ may include linear, branched, and/or cyclic structures. Specific examples of hydrolyzable groups include chlorine, methoxy, ethoxy, and propoxy.

The non-hydrolyzable groups Y′ may be the same or different and are generally not capable of hydrolyzing under conditions for condensation reactions, (e.g., acidic or basic aqueous conditions where hydrolyzable groups are hydrolyzed). The non-hydrolyzable groups Y′ may be independently a hydrocarbon group, for example an alkyl group, for instance having 1 to 6 carbon atoms, or an aryl group. The hydrocarbon group may be fluorinated or non-fluorinated. The alkyl group may be branched or unbranched. In some embodiments, Y′ is selected from the group consisting of a C₁ to C₆ alkyl group and a C₆ to C₁₀ aryl group. For some of these embodiments, the alkyl group is a C₁ to C₄ alkyl group.

Representative fluorochemicals used in the method of this invention include, [C₄F₉SO₂N(CH₃)CH₂]₂CHOCH₂CH₂CH₂Si(OCH₃)₃, [C₄F₉SO₂N(CH₃)CH₂]₂CHOCH₂CH₂CH₂Si(OCH₂CH₃)₃, [C₄F₉SO₂N(CH₃)CH₂]₂CHOC(O)NHCH₂CH₂CH₂Si(OCH₃)₃, [C₄F₉SO₂N(CH₃)CH₂]₂CHOC(O)NHCH₂CH₂CH₂Si(OCH₂CH₃)₃, and C₄F₉SO₂N(CH₃)CH₂CH₂CH₂N(SO₂C₄F₉)CH₂CH₂CH₂Si(OCH₃)₃. In some embodiments, the fluorochemical is selected from the group consisting of [C₄F₉SO₂N(CH₃)CH₂]₂CHOC(O)NH(CH₂)₃Si(OCH₂CH₃)₃, [C₄F₉SO₂N(CH₃)CH₂]₂CHOC(O)NH(CH₂)₃ Si(OCH₃)₃, [C₄F₉SO₂N(CH₃)CH₂]₂CHO(CH₂)₃Si(OCH₂CH₃)₃, C₄F₉SO₂N(CH₃)CH₂CH₂CH₂N(SO₂C₄F₉)CH₂CH₂CH₂Si(OCH₃)₃,

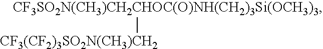

and combinations thereof. In some embodiments, the fluorochemical is

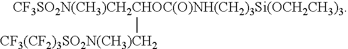

The fluorochemicals described herein may be prepared by known methods. For example, [C₄F₉SO₂N(CH₃)CH₂]₂CHOH may be made by reacting two moles of C₄F₉SO₂NH(CH₃) with either 1,3-dichloro-2-propanol or epichlorohydrin in the presence of base. [C₄F₉SO₂N(CH₃)CH₂]₂CHOCH₂CH₂CH₂Si(OCH₃)₃ can be made from [C₄F₉SON(CH₃)CH₂]₂CHOH by alkylation with ClCH₂CH₂CH₂Si(OCH₃)₃ or by alkylation with allyl chloride, followed by hydrosilation with HSiCl₃ and methanolysis. Reaction of [C₄F₉SO₂N(CH₃)CH₂]₂CHOH with OCNCH₂CH₂CH₂Si(OCH₃)₃ yields [C₄F₉SO₂N(CH₃)CH₂]₂CHOCONHCH₂CH₂CH₂Si(OCH₃)₃. Reaction of [C₄F₉SO₂N(CH₃)CH₂]₂CHOH with OCNCH₂CH₂CH₂Si(OCH₂CH₃)₃ yields [C₄F₉SO₂N(CH₃)CH₂]₂CHOCONHCH₂CH₂CH₂Si(OCH₂CH₃)₃. Reagents used to prepare the compounds are available from general chemical suppliers such as, for example, Sigma-Aldrich Company, Milwaukee, Wis., or may be synthesized by conventional methods.

Without wishing to be bound by theory, it is believed that tenacious side-chains of the fluorochemical are bound to the sandstone through a condensation reaction that provides a W—Si—O—Si bond, wherein W represents the fluorochemical side-chain, which is ultimately covalently bonded to a Si in the sandstone.

The chemical formulation further comprises water, preferably in an amount effective to hydrolyze the hydrolyzable groups. In some embodiments, the amount of water will be in a range from 0.1 to 30% by weight of the total chemical formulation, in particular up to 15% by weight, up to 10% by weight, or up to 5% by weight. In other embodiments, water is present in an amount of at least 1% by weight, at least 5% by weight, or at least 10% by weight of the total chemical formulation. In addition to water, the chemical formulation may comprise a catalyst for hydrolyzing the Si—Y bond. The catalyst may comprise an acid compound or an alkaline compound.

When the catalyst comprises an acid compound, it may be an organic or inorganic acid. Organic acids include, for instance, acetic acid, citric acid, formic acid, triflic acid, perfluorobutyric acid, and combinations thereof. In some embodiments, the organic acid is soluble in a polar organic solvent, also part of the chemical formulation. Inorganic acids include, for example, sulfuric acid, hydrochloric acid, hydroboric acid, phosphoric acid, and combinations thereof. The acid compounds also include acid precursors that form an acid when contacted with water. Combinations of any of these acids are also contemplated by the present chemical formulations.

When the hydrolysis catalyst comprises an alkaline compound, examples include amines, alkali metal hydroxides, alkaline earth metal hydroxides, and combinations thereof. Particular examples include sodium hydroxide, potassium hydroxide, sodium fluoride, potassium fluoride, and trimethylamine.

The hydrolysis catalyst can generally be used in amounts in a range from 0.01 to 10%, but may be used in amount of at least 0.05%, at least 0.1%, at least 1%, or at least 5%, and in amounts up to 8%, up to 5%, up to 1%, or up to 0.1%, by weight based on the total weight of the chemical formulation.

The chemical formulations described herein may further comprise one or more organic solvents (e.g., polar organic solvents). The organic solvent or mixture of organic solvents is capable of dissolving one or more silanes of formula I, and optionally a mixture of silanes of formula I. Additionally, when an organic acid is used, the organic solvent may be chosen so that the organic acid is soluble in the organic solvent. Examples of organic solvents include aliphatic alcohols, (e.g., methanol, ethanol, isopropanol, and butanol); ketones (e.g., acetone and methyl ethyl ketone); esters (e.g., ethyl acetate and methyl formate); ethers (e.g, diethyl ether, tetrahydrofuran (THF), and dipropyleneglycol monomethylether (DPM)); nitriles (e.g., acetonitrile); and formamides (e.g., dimethylformamide). In some embodiments, the polar organic solvent is selected from the group consisting of alcohols, ketones, nitriles, formamides, and combinations thereof. In some embodiments, the polar organic solvent is selected from the group consisting of methanol, ethanol, propanol, butanol, acetone, acetonitrile, dimethylformamide, and combinations thereof. In some embodiments, the polar organic solvent is selected from the group consisting of methanol, ethanol, propanol, butanol, and combinations thereof. In some embodiments, the polar organic solvent is selected such that it has the formula Y—H where Y is the hydrolyzable group of the fluorochemical.

The chemical formulation may be applied to sandstone bearing at least one of oil or gas. Sandstone is known to comprise SiO₂. Typically, sandstone contains in a range of 50 to 80% SiO₂ by weight. Other components of sandstone may include: Al₂O₃, Fe₂O₃, MgO, CaO, Na₂O, K₂O, TiO₂, P₂O₅, and MnO. The temperature of application may, for example, be in a range from 20° C. to 220° C. The temperature may vary from 40° C. and higher, 50° C. and higher, even 100° C. and higher to up to 180° C., up to 150° C., even up to 200° C.

In another aspect, the method may further comprise modifying the wetting of the sandstone. Wettability modification may help increase well deliverability of oil and/or gas in a sandstone formation. Wettability can play a role in condensate accumulation around a wellbore. The effect of wettability on condensate accumulation in porous media can be expressed with the Young-Laplace equation: P_{c}=(2σ cos θ)/r where the capillary pressure P_{c} is proportional to interfacial tension (σ) and the cosine of the pseudocontact angle (cos θ), and is inversely proportional to pore size (r). Thus, according to the Young-Laplace equation, decreasing the cosine of the pseudocontact angle for a given liquid will correspondingly decrease the capillary pressure and thus may increase well deliverability by decreasing condensate accumulation or water around a wellbore.

In one aspect, modifying the wetting of the sandstone is selected from the group consisting of modifying the gas wetting, modifying the liquid wetting, and modifying a combination thereof. In some embodiments, the gas wetting is increased while the liquid wetting is decreased.

Reducing the rate of imbibition of materials such as water, oil, or both, may also improve well deliverability. In some embodiments, the method may further comprise reducing the rate of imbibition of oil in the sandstone. One convenient proxy for measuring the rate of imbibition of hydrocarbon is the measurement of the rate of imbibition of n-decane. Accordingly, in yet another aspect, the method may further comprise reducing the rate of n-decane imbibition of the sandstone. In other embodiments, the method may further comprise reducing the rate of water imbibition of the sandstone.

To measure the wettability effect on condensate accumulation as described above, the present method may comprise injecting a fluid into a sandstone core (e.g., a Berea sandstone core). This injection will produce a maximum pressure drop across the sandstone formation. The method also comprises applying a chemical treatment to the sandstone as described herein. When the wettability of the sandstone is reduced for the liquid injected into the sandstone formation, the method further comprises reducing the maximum pressure drop across the sandstone formation. The effectiveness of the treatment may be manifested as a lower measured pressure drop. The pressure drop, if any, can be 5% or more with respect to the pressure across an untreated core, 10% or more, 20% or more, 30% or more, even 50% or more. The maximum pressure drop can be up to 95%, up to 90%, up to 75%, up to 70%, up to 50%, or even up to 40%.

Compounds of the formula I can be effective in providing high water- and oil-repellency to siliceous substrates as evidenced, for example, by high contact angles for oil and water measured on ceramic tiles coated with the compounds. See co-pending patent application publication number 2006-0147645. High water- and oil-repellency is also evidenced, for example, by high contact angles for oil and water measured on flat glass. The compound of formula [C₄F₉SO₂N(CH₃)CH₂]₂CHOC(O)NH(CH₂)₃Si(OCH₂CH₃)₃, for example, provides a water- and oil-repellent coating to sandstone and flat glass as shown in the Examples below.

In yet another aspect, the method further comprises extracting from the sandstone formation materials selected from the group consisting of oil, gas, and combinations thereof.

The method may further comprise covalently bonding the sandstone with a side-chain derived from the fluorochemical. The side-chain may be represented by the formula II:

[R_{f}SO₂—N(R)(CₙH₂ₙ)]₂CHZ′ (II).

In formula II, each R_{f} is independently —CₚF₂ₚ₊₁, where p is 1 to 8. The perfluoroalkanesulfonamido groups (R_{f}SO₂N—) may be the same or different. The perfluoroalkyl may each contain 1 to 8 carbon atoms and may be linear, branched or cyclic. In some embodiments, each has 2 to 5 carbon atoms, (i.e. p is 2 to 5). In some embodiments, each has 4 carbon atoms.

Also in formula II, each R is independently selected from the group consisting of an aryl group and a C₁ to C₆ alkyl group and n is an integer from 1 to 20.

Z′ is a group of the formula —(CₜH₂ₜ)—X-Q—Si—(Y′)_{w}—, in which t is an integer from 0 to 4. In Z′, -X- is selected from the group consisting of —O—, —S— and —NH—, -Q- is selected from the group consisting of —C(O)NH—(CH₂)ᵥ— and —(CH₂)ᵥ—, Y′ is a non-hydrolyzable group, and w is an integer from 0 to 2. In Q, v is an integer from 1 to 20. In the side-chain defined by formula II the Si atom shares at least one covalent bond with the sandstone. This bond to the sandstone may allow the side-chain to tenaciously alter the wettability of the sandstone. In some embodiments, the bond to the sandstone provides a permanent wettability alteration.

In another aspect, the present description provides a composition comprising a sandstone bearing at least one of oil or gas, and a side-chain covalently bonded to the sandstone. The side-chain is given by formula II. This composition may allow for the expedient extraction of oil and/or gas from a sandstone or sandstone formation bearing at least one of these.

Advantages and embodiments of this invention are further illustrated by the following examples, but the particular materials and amounts thereof recited in these examples, as well as other conditions and details, should not be construed to unduly limit this invention. All parts and percentages are by weight unless otherwise indicated.

### EXAMPLES

For the following examples, single-core testing is carried out by the following procedures:

### Imbibition Measurements:

Liquid was injected into an air-saturated core. The liquid was either tap-water or brine at 24° C. or 140° C., n-decane at 24° C. or tetradecane at 140° C. The air-saturated core was placed in a core-holder. Liquid was injected at the inlet at a constant rate, while the outlet pressure was maintained constant (either atmospheric pressure or 150 psi (1034 kPa)). Liquid injection continued until steady state was achieved. The increase in pressure drop versus time (or pore volume injection) and the average liquid saturation at breakthrough and/or at steady state were measured.

Spontaneous liquid imbibition into the air-saturated cores was measured at temperatures of 24° C., 60° C., and 80° C. for water (tap-water), and at 24° C. for n-decane. The air-saturated core was placed inside the liquid while suspended under an electronic balance. The increase in weight and the average liquid saturation was plotted as a function of the time. If the core was strongly liquid wet, most of the imbibition occurred during the first 30 minutes, where a liquid saturation of more than 60% was obtained, as is the case of untreated Berea sandstone. The rate of imbibition decreased as the wettability is altered to intermediate gas-wetting. Liquid saturation of less than 5% were obtained in some cases after more than 20 hours of imbibition.

### Capillary Pressure Measurements:

Two-core-parallel flow testing was performed with a tap-water or brine injection at 24 or 80° C., and with decane at 24° C. Two air-saturated cores were placed in two core-holders and liquid was injected with a constant rate at the common inlet, while the outlet was open to atmospheric pressure. Both cores were under the same pressure drop. The pressure drop across the system as well as the liquid flow rates in both cores were measured and plotted against time time.

### Preparation of the Compounds

Unless otherwise noted, all parts, percentages, ratios, etc. in the examples and the rest of the specification are by weight.

### Preparation of [C₄F₉SO₂N(CH₃)CH₂]₂CHOH

A three-necked round bottom 1000-mL flask, fitted with a stirrer, heating mantle, condenser, nitrogen inlet, Dean-Stark trap and thermometer was charged with C₄F₉SO₂N(CH₃)H [313 grams (g), 1.00 mole (mol)], generally made as described in U.S. Pat. No. 6,664,354, Example 1, Part A, which patent is incorporated herein by reference, N,N-dimethylformamide (100 g) and heptane (40 g). The mixture was heated to reflux and dried by azeotropic distillation. The mixture was cooled to about 30° C. under nitrogen purge, and sodium methoxide (30% in methanol, 180 g, 1.00 mol) was added. The mixture was heated at 50° C. for one hour, stripping off methanol under vacuum from an aspirator. 1,3-dichloro-2-propanol (65 g, 0.50 mol) was added to the flask and the temperature was elevated to 80° C. and held overnight. The ensuing mixture was washed with deionized water (300 mL at 80° C.) three times and the remaining organic layer was separated and dried in an oven at 120° C. for 1 hour. Vacuum distillation at 150° C. to 200° C. at 0.1 to 0.5 mmHg (13 to 67 Pa) resulted in 275 g of product. Analysis of the resulting yellow brown solid was consistent with [C₄F₉SO₂N(CH₃)CH₂]₂CHOH.

### Preparation of [C₄F₉SO₂N(CH₃)CH₂]₂CHOC(O)NH(CH₂)₃ Si(OCH₂CH₃)₃

A three-necked round bottom 500 mL flask fitted with a stirrer, heating mantle, condenser, nitrogen inlet, Dean-Stark trap and thermometer was charged with [C₄F₉SO₂N(CH₃)CH₂]₂CHOH (204.6 g, 0.300 mol), and methyl ethyl ketone (250 g). The mixture was heated and approximately 50 g of material was removed using the Dean-Stark trap. The mixture was cooled to 30° C., and OCN(CH₂)₃Si(OCH₂CH₃)₃ (74.4 g, 0.301 mol) and three drops of stannous octanoate were added. The mixture was heated at 75° C. under nitrogen for 16 hours. A clear, slightly yellow product ensued. Analysis of the product was consistent with [C₄F₉SO₂N(CH₃)CH₂]₂CHOC(O)NH(CH₂)₃Si(OCH₂CH₃)₃.

### Preparation of [C₄F₉SO₂N(CH₃)CH₂]₂CHOC(O)NHCH₂CH₂CH₂Si(OCH₂CH₃)₃ and Test Solution A

[C₄F₉SO₂N(CH₃)CH₂]₂CHOH (13.6 g, 0.020 mol) was dissolved in 40 mL THF and reacted with OCN(CH₂)₃Si(OCH₂CH₃)₃ (5.0 g, 0.020 mol) and dibutyltin dilaurate (2 drops) in a 125 mL bottle. After 40 hours in a rotating water bath at 60° C., infrared spectroscopy analysis showed no residual isocyanate. This solution (53.9 g) was calculated to be 34.5% solids.

The solution (1.0 g) was diluted with ethanol (29 g), concentrated hydrochloric acid (1.0 g of 37%), and isopropanol (4.5 g) to give a Test Solution A as a 1% solution.

### Preparation of [CF₃SO₂N(CH₃)CH₂]₂CHOH

A mixture of CF₃SO₂NHCH₃ (N-methyltrifluoromethanesulfonamide, generally made as described in U.S. Pat. No. 3,609,187, Example 1) (163 g, 1.00 mol), 50% aqueous sodium hydroxide (40.8 g), and tetrahydrofuran (THF) (250 mL) was treated with epichlorohydrin (45.7 g, 0.50 mol) and stirred at 68° C. for about 18 hours. Unreacted CF₃SO₂NHCH₃ was present as evidenced by an analysis by gas/liquid chromatography (GLC), and more 50% aqueous sodium hydroxide was added in four 10-g portions, waiting an hour after each. The product mixture was cooled, added to an equal volume of water, extracted with dichloromethane, dried over anhydrous MgSO₄, and concentrated to give 167.6 g of an oil, which later solidified. A portion (20 g) was purified by vacuum distillation [boiling point (bp) 192° C./0.5 mmHg (67 Pa)] to provide 16.7 g of [CF₃SO₂N(CH₃)CH₂]₂CHOH.

### Preparation of [CF₃SO₂N(CH₃)CH₂]₂CHOC(O)NH(CH₂)₃Si(OCH₂CH₃)₃ and Test Solution B

In a 125-mL bottle, a solution of [CF₃SO₂N(CH₃)CH₂]₂CHOH (7.6 g, 0.020 mol) in dry THF (40 mL) was treated with OCN(CH₂)₃Si(OCH₂CH₃)₃ (5.0 g, 0.020 mmol) and dibutyltin dilaurate (2 drops). The reaction was heated at 60° C. in a rotating water bath for 40 hours; analysis by infrared spectroscopy indicated no residual isocyanate was present. The resulting solution containing [CF₃ SO₂N(CH₃)CH₂]₂CHOC(O)NH(CH₂)₃ Si(OCH₂CH₃)₃ weighed 53.4 g and was estimated to contain 23.6% solids.

The solution (1.0 g) was diluted with ethanol (18 g), concentrated hydrochloric acid (1.0 g of 37%), and isopropanol (5 g) to give Test Solution B as a 1% solution.

### Preparation of N-methyl-N-(oxiran-2-ylmethyl)perfluorobutane-1-sulfonamide

A mixture of C₄F₉SO₂NHCH₃ (313 g, 1.00 mol) and sodium methoxide (216 g of a 25% solution in methanol) was concentrated to a solid, which was dissolved in dry THF (500 mL). Epichlorohydrin (120.2 g, 1.30 mol) was rapidly added to the resulting solution, and the mixture was stirred at reflux (64° C.) for 20 hours. The cooled mixture was washed with about 1 L of water, and dichloromethane was used to help transfer the organic fraction. The organic fraction was dried over anhydrous MgSO₄, filtered, and concentrated under reduced pressure. The residue was purified by one-plate distillation [bp 90° C./0.06 mmHg (8 Pa)] to provide 155.2 g of N-methyl-N-(oxiran-2-ylmethyl)perfluorobutane-1-sulfonamide, which was 98% pure by GLC.

### Preparation of N-(2-hydroxy-3-{methyl[(trifluoromethyl)sulfonyl]amino}propyl)-N-methylperfluorobutane-1-sulfonamide

A mixture of N-methyl-N-(oxiran-2-ylmethyl)perfluorobutane-1-sulfonamide (3.7 g, 10 mmol) and N-methyltrifluoromethanesulfonamide (1.70 g, 10.4 mmol) in THF (20 mL) was treated with aqueous sodium hydroxide (0.25 g of 50%), and the reaction was heated in a rotating water bath at 60° C. for 18 hours. The THF was removed under reduced pressure to provide an oil. The oil was triturated twice with hexane to provide 4.8 g of N-(2-hydroxy-3-{methyl[(trifluoromethyl)sulfonyl]amino}propyl)-N-methylperfluorobutane-1-sulfonamide as a white solid, mp 79-85° C., which was pure by GLC.

### Preparation of

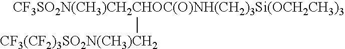

and Test Solution C

A hazy solution of N-(2-hydroxy-3-{methyl[(trifluoromethyl)sulfonyl]amino}propyl)-N-methylperfluorobutane-1-sulfonamide (4.2 g, 7.9 mmol) in dry THF (20 mL) was filtered to remove a trace of insoluble material, and the resulting clear solution was treated with OCN(CH₂)₃Si(OCH₂CH₃)₃ (1.95 g, 7.9 mmol) and dibutyltin dilaurate (1 drop). The reaction was heated at 40° C. on a steam bath for 30 minutes; analysis by infrared spectroscopy indicated no residual isocyanate was present. The resulting solution containing the title compound weighed 30.2 g.

The solution (2.0 g) was diluted with ethanol (38 g), concentrated hydrochloric acid (1.0 g of 37%), and isopropanol (1.8 g) to give Test Solution C as a 1% solution.

### Preparation of N-3-(N-methylperfluorobutanesulfonamido)propylperfluorobutanesulfonamide

3-(N-Methylamino)propylamine (140.8 g, 1.600 mol) was added to a solution of perfluorobutanesulfonyl fluoride (966.4 g, 3.200 mol) and sieve-dried triethylamine (355.52 g, 3.52 mmol) at a rate to support a gentle reflux. The resulting slurry was held at reflux for 27 hours as the pot temperature rose from 66° C. to 104° C. The resulting brown solution was extracted three times with deionized water (700 mL, 500 mL, and 400 mL), each time stirring the two phases aggressively for 30 minutes at 90° C., cooling to 50° C., and decanting the aqueous fraction. The organic fraction was then extracted twice with 3% aqueous sulfuric acid (400 mL and 700 mL) and then twice with deionized water (2×500 mL) using the same extraction method. The organic phase was allowed to cool and air-dried to provide 878.8 g N-3-(N-methylperfluorobutanesulfonamido)propylperfluorobutanesulfonamide.

### Preparation of C₄F₉SO₂N(CH₃)(CH₂)₃N(SO₂C₄F₉)(CH₂)₃Si(OCH₃)₃ and Test Solution D

A mixture of N-3-(N-methylperfluorobutanesulfonamido)propylperfluorobutanesulfonamide (35.7 g, 0.055 mol) and sodium methoxide (12.2 g of a 25% solution in methanol) was concentrated under reduced pressure, and the resulting solid was dissolved in diglyme (100 mL). Cl(CH₂)₃Si(OCH₃)₃ (11.7 g) was added, and the reaction was stirred overnight at 105° C. Analysis by GLC indicated the reaction was incomplete, and the mixture was heated at 129° C. for 8 hours. The product was purified by vacuum distillation [200-220° C./0.6 mmHg (80 Pa)] to provide C₄F₉SO₂N(CH₃)(CH₂)₃N(SO₂C₄F₉)(CH₂)₃Si(OCH₃)₃ as a tan semi-solid.

A sample of C₄F₉SO₂N(CH₃)(CH₂)₃N(SO₂C₄F₉)(CH₂)₃Si(OCH₃)₃ (0.5 g) was diluted with ethanol (45 g), concentrated hydrochloric acid (1 g of 37%), and isopropanol (4 g) to give a hazy solution as Test Solution D.

### Example 1

A core of Berea sandstone was treated with a chemical formulation containing 25% by weight of a fluorochemical represented by the formula: [C₄F₉SO₂N(CH₃)CH₂]₂CHOC(O)NH(CH₂)₃Si(OCH₂CH₃)₃, 5% by weight water, 5% by weight acetic acid, 65% by weight ethanol. The chemical formulation was applied to the sandstone core at 140° C. The following treatment procedure was used. In an oven at 140° C., a pretreatment solution of water, acetic acid, and ethanol was injected into the core for five pore volumes. The chemical formulation described above was then injected for five pore volumes. The core was then aged overnight at 200 psi (1380 kPa) and 140° C.

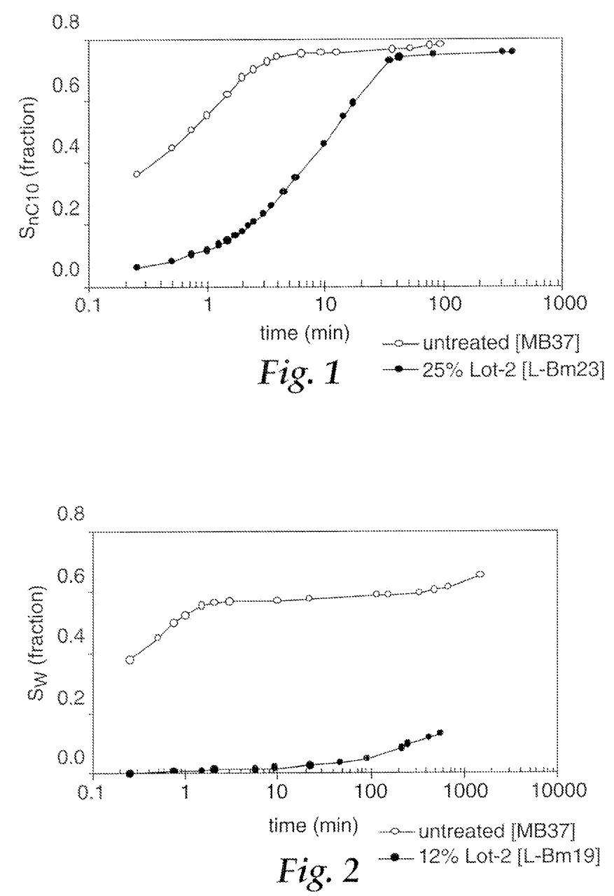

The n-decane imbibition of an untreated Berea sandstone core and that of the treated core was measured at 24° C. The results are shown in FIG. 1.

### Example 2

A core of Berea sandstone was treated with a chemical formulation containing 12% by weight of a fluorochemical represented by the formula: [C₄F₉SO₂N(CH₃)CH₂]₂CHOC(O)NH(CH₂)₃Si(OCH₂CH₃)₃, 5% by weight water, 5% by weight acetic acid, 73% by weight ethanol. The chemical formulation was applied to the sandstone core at 140° C.

The water imbibition of an untreated Berea sandstone core and that of the treated core was measured at 24° C. The results are shown in FIG. 2.

### Example 3

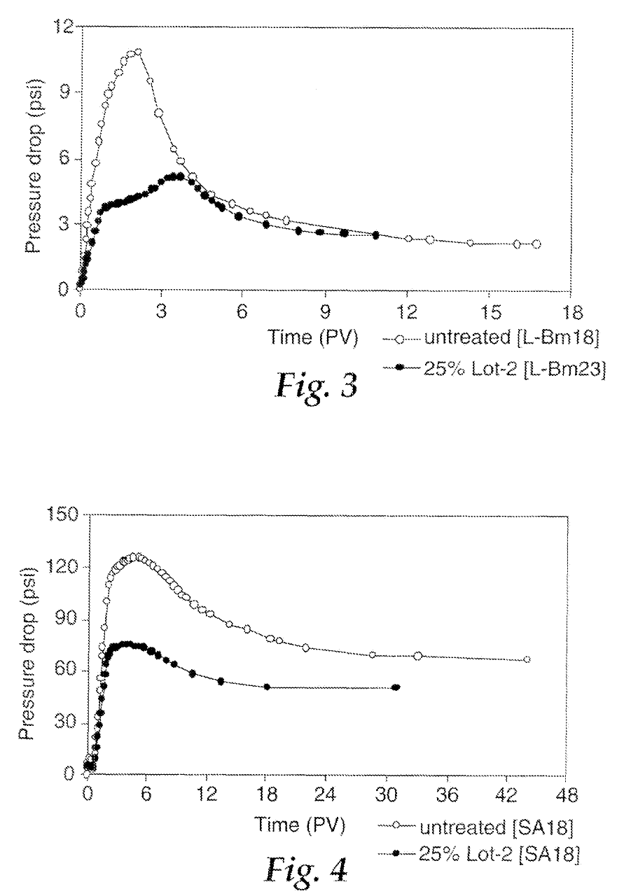

A treated Berea sandstone core was prepared as described in Example 1. In both the treated and untreated cores, n-decane was injected into the cores at a constant rate of 2 cc/min at 24° C. The pressure drop (capillary pressure) across the core was measured. The result for the treated core and untreated core are presented in FIG. 3.

### Example 4

A treated reservoir sandstone core was prepared as described in Example 1. Water was injected across the core both before treatment and after treatment. Water was injected at a rate of 7 cc/min. The pressure drop (capillary pressure) across the core was measured for both the treated core and the untreated core. The results for the treated core and untreated core are presented in FIG. 4.

### Example 5

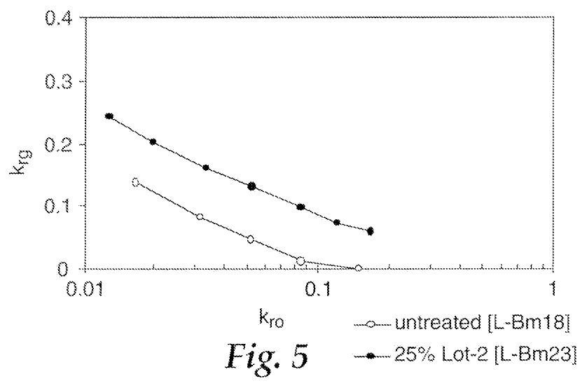

A treated Berea sandstone core was prepared as described in Example 1. In each core, nitrogen and n-decane were simultaneously injected with a fixed pressure drop of 7 psi (48.3 kPa) at 24° C. The relative permeability of decane and nitrogen were measured. FIG. 5 shows a plot of the results. Treatment did not decrease absolute permeability.

### Example 6

A treated Berea sandstone core was prepared as described in Example 1. The contact angle was visually estimated for both water/gas and oil/gas systems. These contact angles were compared to the contact angles for systems identical except that they include an untreated, rather than treated core. The results are shown in Table 1, below.

TABLE 1

| | | | Oil/Gas |
|---|---|---|---|
| | | Water/Gas | Pseudocontact |
| Core Type | Treatment | Pseudocontact Angle | Angle |
| Berea | No | 0° | 0° |
| Berea | Yes | 160° | 50° |

### Coating of Test Solutions

Glass slides were immersed in the test solutions A through D at room temperature for 15 seconds, withdrawn at 0.1 inch per second, and allowed to dry. Test solutions A, B, and D were used to coat glass slides about one week after they were prepared. Test solution C was used to coat a glass slide within two days of preparation.

### Contact Angle Measurement

Advancing and receding contact angles versus water and n-hexadecane were measured on the coated glass slides prepared above using a KRUSS G120/G140 MKI goniometer (Kruss USA, Charlotte, N.C.). Larger values of contact angles indicate better repellency. The values reported in Table 2 (below) are the mean values of 2 to 4 measurements and are reported in degrees.

TABLE 2

| | | Contact Angle |
|---|---|---|
| Test Solution Used for | Contact Angle Water (°) | Hexadecane (°) |
| Glass Slide | Advancing, Receding | Advancing, Receding |
| A | 100, 65 | 74, 39 |
| B | 84, 40 | 44, 9 |
| C | 97, 40 | 60, 37 |
| D | 107, 51 | 70, 46 |

Various modifications and alterations of the invention may be made by those skilled in the art without departing from the scope and spirit of the invention, and it should be understood that this invention is not to be unduly limited to the illustrative examples.

What is claimed is:

1. A method for modifying the wettability of sandstone, the method comprising applying a chemical formulation to sandstone, the sandstone bearing at least one of oil or gas, and the chemical formulation comprising:
a polar organic solvent,
water,
a fluorochemical represented by the formula:
R_{f}SO₂—N(R)(CₙH₂ₙ)CHZ(CₘH₂ₘ)N(R′)SO₂R_{f}
wherein
each R_{f} is independently —CₚF₂ₚ₊₁, where p is an integer from 1 to 8;
R is selected from the group consisting of an aryl group and a C₁ to C₆ alkyl group;
m and n are each independently integers from 1 to 20;
Z is selected from the group consisting of —H and a group having the formula —(CₜH₂ₜ)—X-Q—Si(Y′)_{w}(Y)_{3-w}, in which t is an integer from 0 to 4; -X- is selected from the group consisting of —O—, —S— and —NH—; -Q- is selected from the group consisting of —C(O)NH—(CH₂)ᵥ— and —(CH₂)—; v is an integer from 1 to 20; Y is a hydrolyzable group; Y′ is a non-hydrolyzable group; and w is an integer from 0 to 2; and
R′ is selected from R and a group represented by the formula —(CH₂)ᵥ—Si(Y′)_{w}(Y)_{3-w}, with the proviso that when Z is —H, R′ is a group represented by the formula —(CH₂)ᵥ—Si(Y′)_{w}(Y)_{3-w}; and
a hydrolysis catalyst for hydrolyzing the Si—Y bond, the hydrolysis catalyst comprising an acid compound or alkaline compound.

2. The method of claim 1, wherein p is an integer from 2 to 5.

3. The method of claim 1, wherein p is 4, m is an integer from 1 to 6, and n is an integer from 1 to 6.

4. The method of claim 1, wherein p is 4; R is —CH₃; m and n are both 1; and Z is selected from the group consisting of —O—(CH₂)₃Si(OCH₂CH₃)₃, —O—(CH₂)₃Si(OCH₃)₃, —OC(O)NH(CH₂)₃Si(OCH₂CH₃)₃, and —OC(O)NH(CH₂)₃Si(OCH₃)₃.

5. The method of claim 1, wherein each Y is independently selected from the group consisting of a halogen, a C₁ to C₆ alkoxy group, a C₁ to C₆ acyloxy group, and an aryloxy group.

6. The method of claim 1, wherein Z is —H and R′ is —(CH₂)ᵥ—Si(Y)₃ and wherein each Y is independently selected from the group consisting of —Cl and a C₁ to C₆ alkoxy group.

7. The method of claim 1, wherein the fluorochemical is selected from the group consisting of [C₄F₉SO₂N(CH₃)CH₂]₂CHOC(O)NH(CH₂)₃ Si(OCH₂CH₃)₃, [C₄F₉SO₂N(CH₃)CH₂]₂CHOC(O)NH(CH₂)₃ Si(OCH₃)₃, [C₄F₉SO₂N(CH₃)CH₂]₂CHO(CH₂)₃Si(OCH₂CH₃)₃, C₄F₉SO₂N(CH₃)CH₂CH₂CH₂N(SO₂C₄F₉)CH₂CH₂CH₂Si(OCH₃)₃, 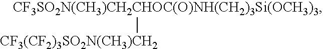
and combinations thereof.

8. The method of claim 1, wherein Y′ is selected from the group consisting of a C₁ to C₆ alkyl group and a C₆ to C₁₀ aryl group.

9. The method of claim 8, wherein Y′ is non-fluorinated.

10. The method of claim 8, wherein the alkyl group is unbranched.

11. The method of claim 1, wherein the polar organic solvent is selected from the group consisting of alcohols, ketones, nitriles, formamides, and combinations thereof.

12. The method of claim 1, wherein the polar organic solvent is selected from the group consisting of methanol, ethanol, propanol, butanol, acetone, acetonitrile, dimethylformamide, and combinations thereof.

13. The method of claim 1, wherein the polar organic solvent is selected from the group consisting of methanol, ethanol, propanol, butanol, and combinations thereof.

14. The method of claim 1, wherein Y is selected such that the polar organic solvent is represented by the formula Y—H.

15. The method of claim 1, wherein the acid compound is selected from the group consisting of an organic acid, an inorganic acid, and combinations thereof.

16. The method of claim 15, wherein the acid is an organic acid and wherein the organic acid is soluble in the polar organic solvent.

17. The method of claim 15, wherein the acid is an organic acid and wherein the organic acid is selected from the group consisting of acetic acid, citric acid, formic acid, triflic acid, perfluorobutyric acid, and combinations thereof.

18. The method of claim 15, wherein the acid is an inorganic acid selected from the group consisting of hydroboric acid, sulfuric acid, phosphoric acid, hydrochloric acid, and combinations thereof.

19. The method of claim 1, wherein the acid compound is an acid precursor which forms an acid when contacted with water.

20. The method of claim 1, wherein the alkaline compound is selected from the group consisting of an amine, an alkali metal hydroxide, an alkaline earth metal hydroxide, and combinations thereof.

21. The method of claim 1, wherein applying takes place at least one temperature in a range from 20° C. to 220° C.

22. The method of claim 1, further comprising modifying the wetting of the sandstone.

23. The method of claim 22, wherein the wetting is selected from the group consisting of gas wetting, liquid wetting, and combinations thereof.

24. The method of claim 1, further comprising reducing the rate of n-decane imbibition of the sandstone.

25. The method of claim 1, further comprising reducing the rate of water imbibition of the sandstone.

26. The method of claim 1, further comprising injecting a liquid into the sandstone formation, producing a maximum pressure drop across the sandstone formation, and reducing the maximum pressure drop.

27. The method according to claim 26, wherein the maximum pressure drop is reduced by from 10% to 90%.

28. The method according to claim 1, further comprising extracting from the sandstone formation materials selected from the group consisting of oil, gas, and combinations thereof.

29. The method of claim 1, further comprising covalently bonding the sandstone with a side-chain derived from the fluorochemical, the side-chain represented by the formula
[R_{f}SO₂—N(R)(CₙH₂ₙ)]₂CHZ′
wherein
each R_{f} is independently —CₚF₂ₚ₊₁ where p is an integer from 1 to 8;
each R is independently selected from the group consisting of an aryl group and a C₁ to C₆ alkyl group;
n is an integer from 1 to 20; and
Z′ is a group of the formula —(CₜH₂ₜ)—X-Q—Si(Y′)_{w}—, in which t is an integer from 0 to 4; -X- is selected from the group consisting of —O—, —S— and —NH—; -Q- is selected from the group consisting of —C(O)NH—(CH₂)ᵥ— and —(CH₂)ᵥ—; v is an integer from 1 to 20; Y′ is a non-hydrolyzable group, w is an integer from 0 to 2; and the Si atom shares at least one covalent bond with the sandstone.

30. The method of claim 29, wherein p is an integer from 2 to 5.

31. A composition comprising a sandstone bearing at least one of oil or gas, and a side-chain covalently bonded to the sandstone, the side-chain represented by the formula:
[R_{f}SO₂—N(R)(CₙH₂ₙ)]₂CHZ′
wherein
each R_{f} is independently —CₚF₂ₚ₊₁, where p is an integer from 1 to 8;
each R is independently selected from the group consisting of an aryl group and a C₁ to C₆ alkyl group;
n is an integer from 1 to 20; and
Z′ is a group of the formula —(CₜH₂ₜ)—X-Q—Si(Y′)_{w}—, in which t is an integer from 0 to 4; -X- is selected from the group consisting of —O—, —S— and —NH—;
-Q- is selected from the group consisting of —C(O)NH—(CH₂)ᵥ— and —(CH₂)ᵥ—; v is an integer from 1 to 20; Y′ is a non-hydrolyzable group; w is an integer from 0 to 2; and the Si atom shares at least one covalent bond with the sandstone.

32. The composition of claim 31, wherein p is an integer from 2 to 5.
